(19) United States
(12) Patent Application Publication
(10) Pub. No.: US 2021/0306602 A1
(43) Pub. Date: Sep. 30, 2021

(54) LED Mirror Display

(71) Applicant: Eric Don Davis, Sammamish, WA (US)

(72) Inventor: Eric Don Davis, Sammamish, WA (US)

(21) Appl. No.: 17/249,534

(22) Filed: Mar. 4, 2021

Related U.S. Application Data
(60) Provisional application No. 63/001,843, filed on Mar. 30, 2020.

(51) Int. Cl. H04N 9/31; G06F 3/01

(52) U.S. Cl. CPC H04N 9/3152; G03B 21/2033; G06F 3/011; H04N 9/3155

(57) ABSTRACT

Apparatus for generating an image on a surface and associated methods are disclosed. In some embodiments, the apparatus includes (i) a screen, (ii) a housing positioned to hold the screen; (iii) a light source positioned in the enclosure to emit light in a first direction; (iv) a reflector positioned to direct the light from the light source toward the screen; and (v) a driving mechanism positioned to drive the reflector to move in a second direction generally perpendicular to the first direction. The operations of the light source and the driving mechanism are coordinated so as to generate the image on the surface.

### CROSS-REFERENCE TO RELATED APPLICATION

This application claims priority to U.S. Provisional Patent Application No. 63,001,843, filed on Mar. 30, 2020, the entire content of which is incorporated herein by reference.

### TECHNICAL FIELD

The present technology is directed to an image displaying device. More particularly, some embodiments of the present technology relate to a display having a light source and one or more reflectors configured to direct light from the lighting source.

### BACKGROUND

Rear-projection displays are widely used for large-scale visual presentation such as a home theater system. Nowadays, consumers generally expect a display to be compact and thin. Traditional rear-projection displays are relatively thick because they require sufficient spaces/distances between their light sources and their screens. This space/distance requirement makes reducing the sizes of the traditional rear-projection displays difficult and challenging. Therefore, it is beneficial to have an improved design to address the foregoing issue.

### BRIEF DESCRIPTION OF THE DRAWINGS

Many aspects of the present technology can be better understood with reference to the following drawings. The components in the drawings are not necessarily to scale. Instead, emphasis is placed on illustrating the principles of the present technology.

FIG. 1 is a schematic diagram of an image displaying device in accordance with embodiments of the present technology.

FIGS. 2A-2E are schematic diagrams illustrating operations of the image displaying device in accordance with embodiments of the present technology.

FIG. 3 is a schematic diagram illustrating viewing areas of the image displaying device in accordance with embodiments of the present technology.

FIG. 4 is a schematic diagram of another image displaying device in accordance with embodiments of the present technology.

FIG. 5 is a schematic diagram illustrating operations of an image displaying device in accordance with embodiments of the present technology.

FIG. 6 is a schematic diagram of a reflector in accordance with embodiments of the present technology.

FIG. 7 is a schematic diagram of a system in accordance with embodiments of the present technology.

FIG. 8 is a flowchart illustrating a method in accordance with embodiments of the present technology.

FIG. 9 is a flowchart illustrating a method in accordance with embodiments of the present technology.

### DETAILED DESCRIPTION

The present technology is directed to an image displaying device with a compact, thin design. The image displaying device includes a light source positioned and configured to emit light in a first (e.g., vertical) direction. The image displaying device also includes multiple reflectors positioned and configured to move in a second (e.g., horizontal) direction. In some embodiments, the second direction is generally perpendicular to the first direction. This arrangement enables the reflector to direct light from the light source (to a screen of the image displaying device) for a user to observe. The image displaying device has a reduced dimension (more particularly, in the second direction) and therefore can have a compact, thin overall design.

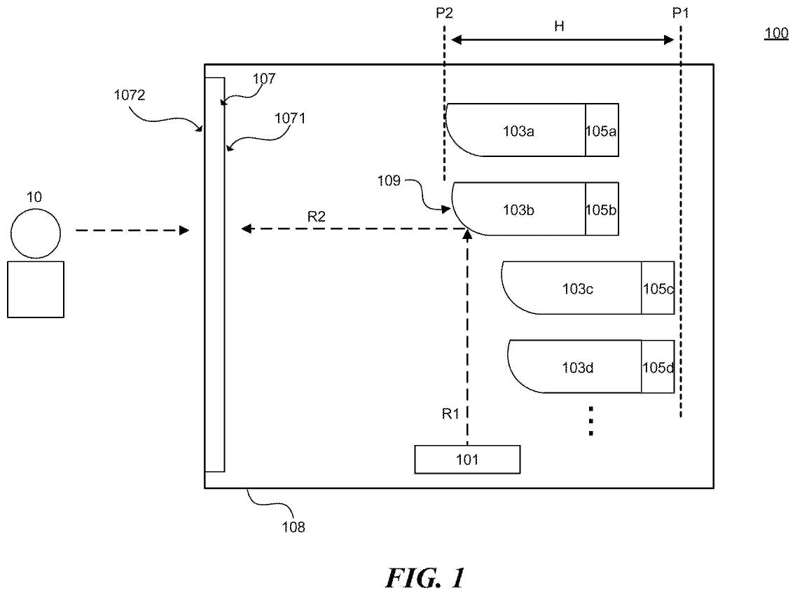

FIG. 1 is a schematic diagram of a display or an image displaying device 100 in accordance with embodiments of the present technology. FIG. 1 is a schematic side view of the image displaying device 100. The image displaying device 100 includes a light source 101, multiple reflectors 103 (only four reflectors 103a-d are shown in FIG. 1) operably translated linearly by corresponding driving mechanisms 105 (only four driving mechanisms 105a-d are shown in FIG. 1), a screen 107, and a housing 108 configured to accommodate the foregoing components. The screen 107 has an interior surface 1071 and an exterior surface 1072.

In some embodiments, the light source 101 includes a light-emitting diode (LED) component, a laser, and/or other suitable light emitting devices. The LED component can include more than one LEDs configured to emit light rays in different colors (yellow, green, blue, red, orange, white, etc.) with various brightness levels. The LED component can be controlled by a light-source controller such as an LED circuit. The LED circuit is configured to apply different voltages to the LED component so as to generate light with various characteristics.

As shown in FIG. 1, the light source 101 emits light in direction R1. As shown, the reflector 103b includes a curved surface 109 configured to reflect the light from the light source 101. The emitted light is reflected or directed by the curved surface 109 of the reflector 103b toward the interior surface 1071 of the screen 107 in direction R2. The reflected/directed light can then be observed or viewed by a user 10 from the exterior surface 1072 of the screen 107.

The multiple reflectors 103a-d are coupled to and/or driven by the driving mechanisms 105a-d, respectively. Accordingly, the multiple reflectors 103a-d can be moved back and forth in direction H between a rear position P1 and a front position P2. By moving the multiple reflectors 103a-d and coordinating their movements with the light source 102 (e.g., emitting light with various combinations of brightness, color, etc. depending on the locations of the multiple reflectors 103a-d), the light from the light source 101 can be reflected and distributed to desirable viewing areas on the interior surface 1071 of the screen 107. Repeating the foregoing operations (e.g., generating images in multiple viewing areas so as to form images on the whole screen 107), the image displaying device 100 can generate desirable images on the screen 107 by the light source 101, without requiring additional light sources. The generated images can be images (e.g., color images, black and white images, etc.) each reflected by one of the reflectors 103a-d. The light source 101 can include an array of RGB LEDs configured to output the color images. The number and configuration of the light sources 101 can be selected based on the number of multiple reflectors 103a-d. For example, a first light source can direct light toward a first group of reflectors, and a second light source can direct light towards a second group of reflectors to form a large composite image on the screen.

In some embodiments, the driving mechanisms 105a-d can include a linear motor, a mass driver, a coil gun, etc. The driving mechanisms can include multiple coils functioning as electromagnets so as to move (or be moved by) corresponding magnets. In some embodiments, the magnets can be attached to the reflectors 103a-d, individually. In some embodiments, the driving mechanisms 105a-d can include a pneumatic device positioned/configured to move the reflector 103a-d by air pressure. In some embodiments, the driving mechanisms 105a-d can include a hydraulic device positioned/configured to move the reflectors 103a-dby fluid pressure. In some embodiments, the driving mechanisms 105a-d can include rollers, gears, and/or idler configured to move and/or restraint the movement of the reflectors 103a-d.

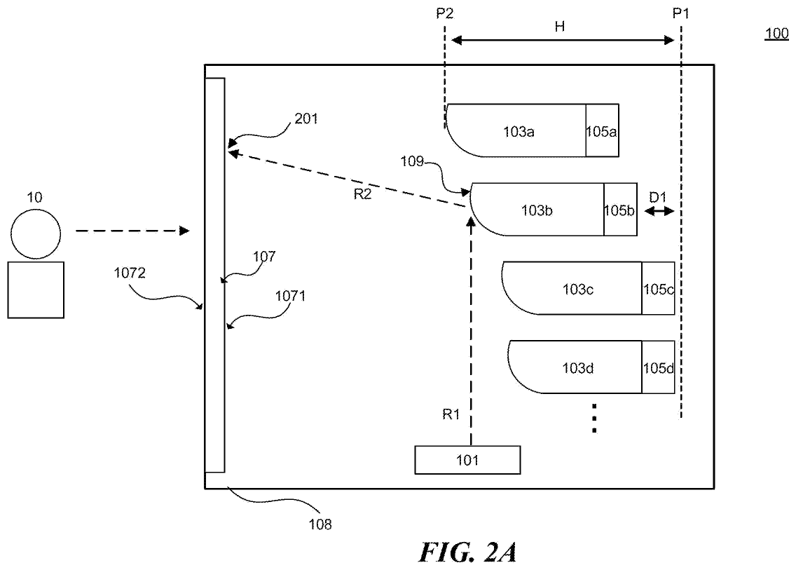

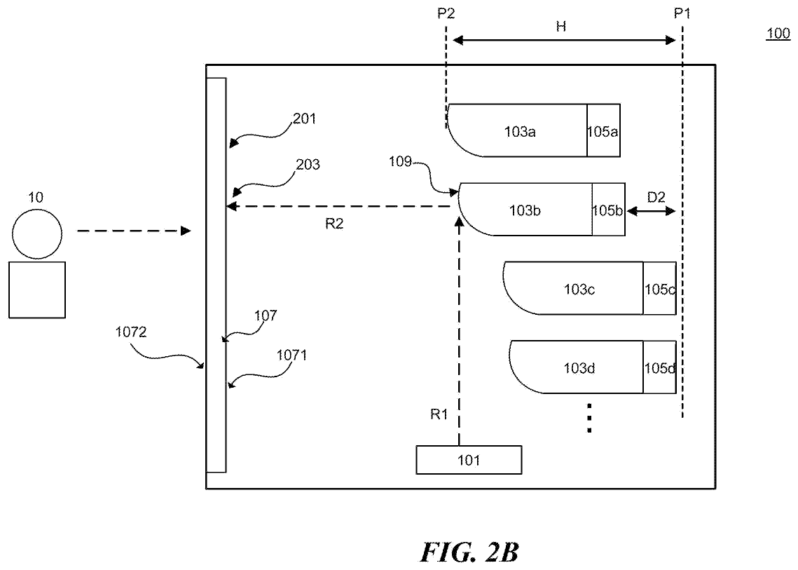

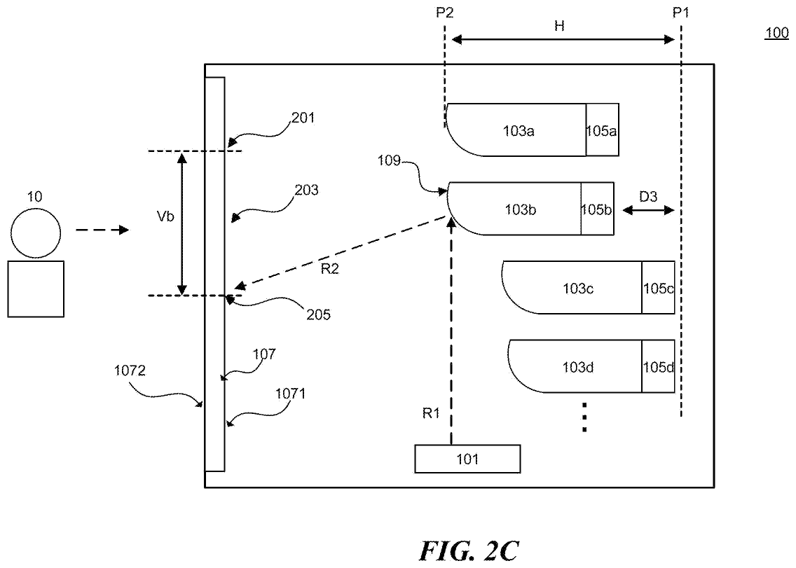

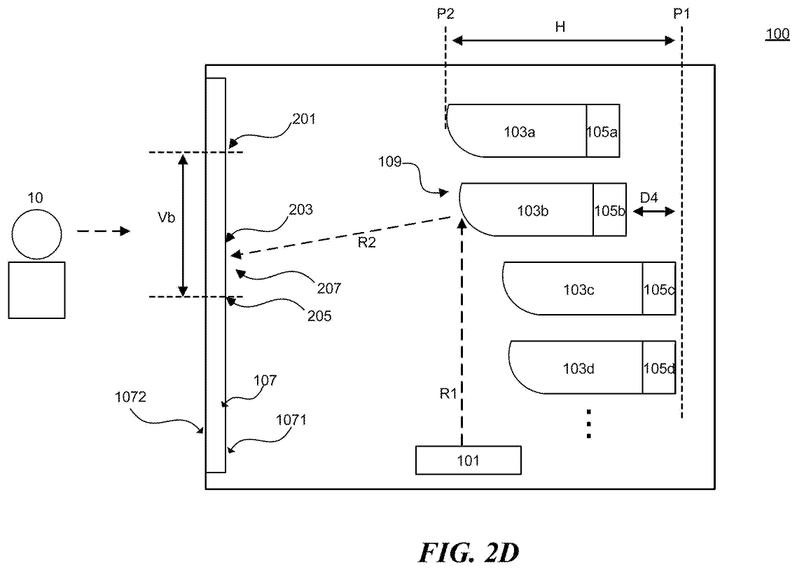

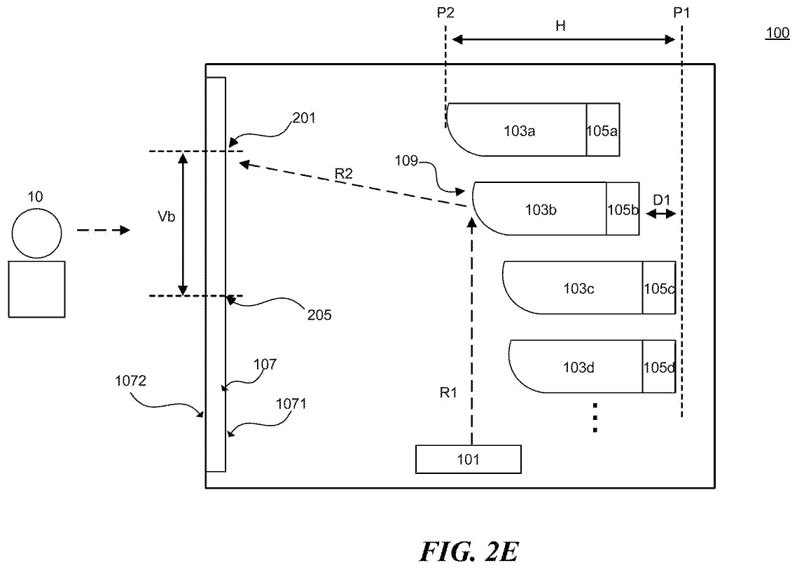

The operations of the image displaying device 100 are to be discussed in detail with reference to FIGS. 2A-2E (using the reflector 103b as an example). In FIG. 2A, the reflector 103b has moved or traveled a distance D1 from the rear position P1 toward the screen 107. When the curved surface 109 first receives the light from the light source 101 in direction R1, the curved surface 109 then directs the incoming light to an upper point 201 on the interior surface 1071 of the screen 107.

Referring to FIG. 2B, the reflector 103b keeps moving to a location which has a distance D2 away from the rear position P1. At this point, the curved surface 109 receives the light from the light source 101 and directs it to a middle point 203 on the interior surface 1071 of the screen 107.

Referring to FIG. 2C, the reflector 103b keeps moving to the front position P2 (where the reflector 103b is away from the rear position P1 by a distance D3). At this point, the curved surface 109 receives the light from the light source 101 and directs it to a lower point 205 on the interior surface 1071 of the screen 107. As shown in FIG. 2C, by the movements of the reflector 103b described in FIG. 2A-2C, the reflector 103b has been directing light to the screen 107 from the upper point 201 to the lower point 205. In other words, the directed light from the reflector 103b has completed a “top-down” scan of a viewing area Vb. The viewing area Vb shown in FIG. 2C indicates an area where the user 10 can observe the light directed by the reflector 103b from the exterior surface 1072 of the screen 107. This “top-down” scan is a first half of a scan cycle of the reflector 103b.

Referring to FIG. 2D, a second half of the scan cycle of the reflector 103b starts by moving the reflector 103b back from the front position P2 toward the rear position P1. For example, when the reflector 103b is away from the rear position P1 by a distance D4, the curved surface 109 receives the light from the light source 101 and directs it to a point 207 on the interior surface 1071 of the screen 107.

Referring now to FIG. 2E, when the reflector 103b moves back to the location where the reflector 103b is away from the rear position P1 by the distance D1, the reflector 103b has completed the second half (e.g., a “bottom-up” scan) of the scan cycle. Namely, during the processes illustrated in FIGS. 2C-2E, the directed light from the curved surface 109 has completely scanned the viewing area Vb one time from the bottom to the top (e.g., from the lower point 205 to the upper point 201), which the reflector 103b has been directing light to the screen 107 from the upper point 201 to the lower point 205.

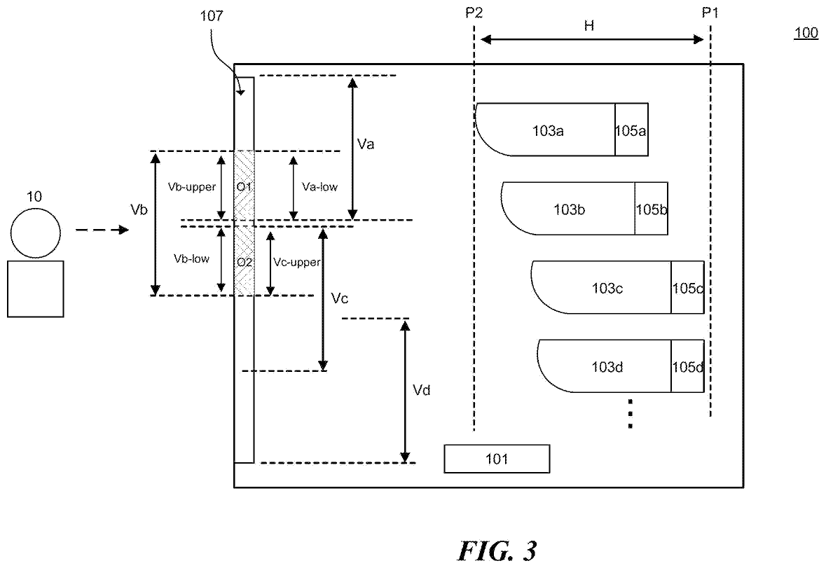

Referring to FIGS. 2A-2E, for each time that the reflector 103b completes the scan cycle (e.g., from the location shown in FIG. 2A to the location shown in FIG. 2E), the light directed from the curved surface 109 can scan the viewing area Vb twice, including the “top-down” scan and the “bottom-up” scan. After each of the multiple reflectors 103a-b completes its scan cycle, a whole images can be shown on the screen 107 by combining/overlapping corresponding viewing areas, which is discussed in detail with reference to FIG. 3. By the foregoing configuration, the light from the light source 101 can be effectively directed to the screen 107.

FIG. 3 is a schematic diagram illustrating viewing areas Va-d (including the viewing area Vb discussed above in FIGS. 2C-2E) of the image displaying device 100 in accordance with embodiments of the present technology. The light directed by the reflector 103a can be viewed by the user 10 in the viewing area Va. Similarly, the light directed by the reflector 103c can be viewed by the user 10 in the viewing area Vc, and the light directed by the reflector 103d can be viewed by the user 10 in the viewing area Vd. The viewing areas Va, Vc, and Vd can be “scanned” by the reflectors 103a, 103c, and 103d, respectively in the ways similar to those discussed above with respect to the reflector 103b.

In the embodiment illustrated in FIG. 3, the dimensions/sizes of the viewing areas Va-d are generally the same. As shown, a lower portion Va-low of the viewing area Va overlaps an upper portion Vb-upper of the viewing areas Vb to form a first overlapped area O1. The first overlapped area O1 can be illuminated by the light directed from either the reflector 103a or reflector 103c.

Similarly, a lower portion Vb-low of the viewing area Vb overlaps an upper portion Vc-upper of the viewing areas Vc to form a second overlapped area O2. The second overlapped area O2 can be illuminated by the light directed from either the reflector 103b or the reflector 103c.

In the illustrated embodiment, the first overlapped area O1 is not in direct contact with the second overlapped area O2. In other embodiments, the first overlapped area O1 can be adjacent to the second overlapped area O2. In some embodiments, the first overlapped area O1 and the second overlapped area O2 can be overlapped. Similarly, the viewing areas Vc can also share an overlapped area with the viewing areas Vd. In some embodiments, the adjacent viewing areas can be next to each other without overlapping.

In some embodiments, the dimensions/sizes of the viewing areas Va-d can be different. For example, the viewing area Va close to the top of the screen 107) can be larger than the viewing area Vb (e.g., closer to the center of the screen 107). As another example, the viewing area Vd (e.g., close to the bottom of the screen 107) can be larger than the viewing area Vc (e.g., close to the center of the screen 107).

In other embodiments, however, the dimensions/sizes of the viewing areas Va-d can vary depending on various design factors of the image displaying device 100. The locations of the reflectors 103a-d can be considered when determining the dimensions/sizes of the viewing areas Va-d and the overlapping, if any, among these areas. For example, when two reflectors 103 are vertically closer, these two reflectors 103 would have a larger overlapping area, if any. The position of the two reflectors 103 can be set by the user 10 (via a remote, controller, smartphone, etc.) and/or, detected using one or more sensor (e.g., thermal sensors, motion sensors, etc.)

In some embodiments, the shapes of the reflectors 103 can also affect the dimensions/sizes of the corresponding viewing areas. In some embodiments, the curved surfaces 109 of individual reflectors 103 can be different such that the resulting viewing areas can be different. For example, curved surfaces with higher curvatures result in larger viewing areas.

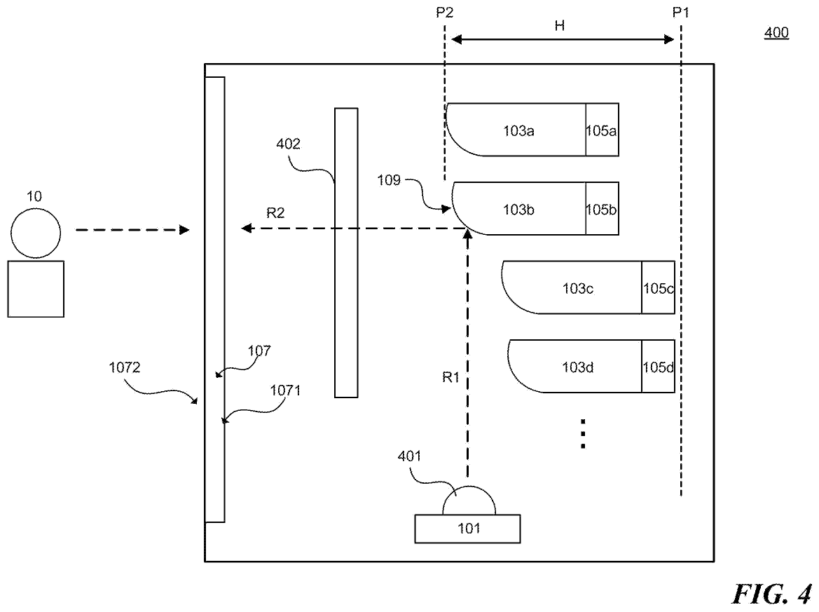

FIG. 4 is a schematic diagram of an image displaying device 400 in accordance with embodiments of the present technology. Compared to the embodiments described above with reference to FIGS. 1-3, the image displaying device 400 includes a light adjustment element 401 positioned adjacent to the configured to light source 101. The light adjustment element 401 is configured to focus, guide, or direct light from the light source 101 toward the reflectors 103. For example, the light adjustment element 401 can facilitate directing or focusing light rays in direction R1 (a vertical or generally vertical direction) toward the reflectors 103. In some embodiments, the light adjustment element 401 can include one or more sets of lenses, light guides, and/or other suitable components. This improves an overall efficiency of the image displaying device 400 at least by (i) preventing light from the light source 101 from directly reaching the screen 107 without first being reflected by one of the reflectors 103; and (ii) effectively using the light from the light source 101 so as to enhance the brightness of the viewing areas.

In some embodiments, the image displaying device 400 can have more than one light adjustment elements 401. For example, each of the reflectors 103 can have a corresponding one light adjustment element 401 positioned adjacent thereto. In some embodiments, each of the multiple light adjustment elements 401 can have the same or similar optical characteristics. Examples of the optical characteristics include a focal length, curvature, transparency, color, etc.

In other embodiments, the optical characteristics of the multiple light adjustment elements 401 can be different. For example, for a first light adjustment element that is closer to the light source 101, it can have a higher transparency, less color, a longer focal length, compared to a second light adjustment element that is away from the light source 101.

The shapes of the light adjustment elements 401 can vary in different embodiments. For example, the light adjustment elements 401 can be shaped in accordance with the light source 101. The shapes of the light adjustment elements 401 can also be determined to conform with the shapes/locations of the reflectors 103.

The image displaying device 400 can include a lens or light filter 402 positioned adjacent to the reflectors 103. The light filter 402 is configured to adjust the characteristics of the directed light from the reflectors 103. In the illustrated embodiments, there is only one lens shown in FIG. 4. In other embodiments, there can be multiple light filters 402 (e.g., each reflector 103 can have a corresponding light filter).

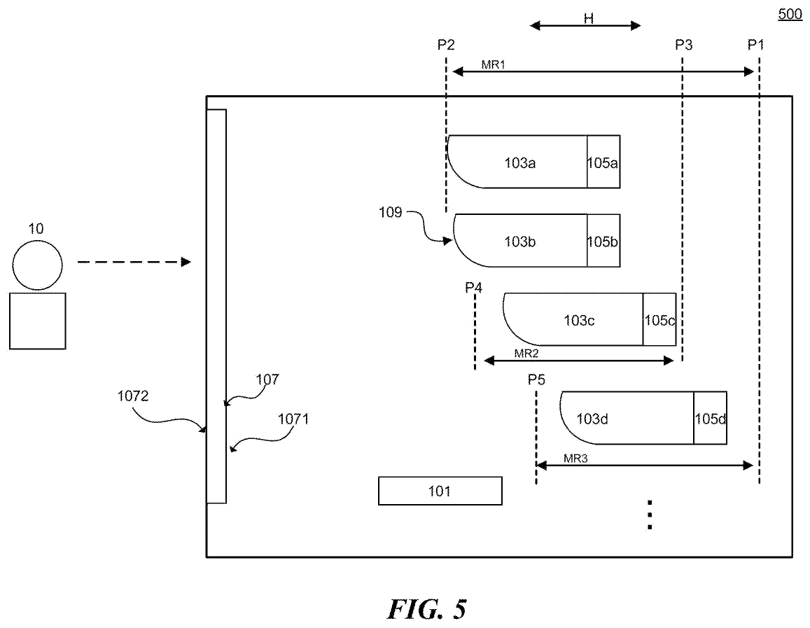

FIG. 5 is a schematic diagram illustrating operations of an image displaying device 500 in accordance with embodiments of the present technology. In the embodiments discussed in FIGS. 1-4, the reflectors 103a-d are positioned to move back and forth in direction H between the rear position P1 and the front position P2. In the embodiments illustrated in FIG. 5, a moving range MR of each of the reflectors 103a-d can be individually configured. For example, the reflectors 103a and 103b can have the same moving range MR1, which starts from position P3 to the front position P2. The reflector 103c has a moving range MR2, starting from position P3 to position P4. The reflector 103d can be moved in a moving range MR3.

Factors for determining the moving ranges MRs of the reflectors 103 include the size/dimension of the screen 107, the types and optical characteristics the light source 101, an overall size/dimension of the image displaying device 500, the sizes/dimensions of the reflectors 103, the sizes/dimensions of the driving mechanisms 105, and other suitable factors. For example, the screen 107 can be a curved screen. In such embodiments, the moving ranges MRs of the reflectors 103 can be individually determined to present images on the curved screen with required brightness at various locations of the curved screen.

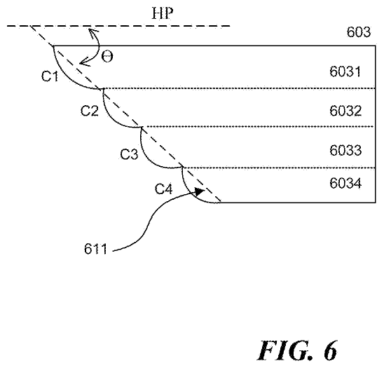

FIG. 6 is a schematic diagram of a reflector 603 in accordance with an embodiment of the present technology. The reflector 603 includes two or more portions. In FIG. 6, four portions (a first portion 6031, a second portion 6032, a third portion 6033, and a fourth portion 6034) are illustrated as an example. The first portion 6031 includes a first curved surface C1, the second portion 6032 includes a second curved surface C2, the third portion 6033 includes a third curved surface C3, and the forth portion 6034 has a fourth curved surface C4. In the illustrated embodiment, the first, second, third, and fourth curved surfaces C1-C4 have generally the same curvature. In other embodiments, however, the curvature of each curved surface can be different.

As shown in FIG. 6, the first, second, third, and fourth curved surfaces C1-C4 are aligned or generally aligned with one another in a reference plane 611. The reference plane 611 forms an angle θ relative to a horizontal plane HP. The angle θ can have a range from 20 to 70 degrees. In some embodiments, the reference plane 611 can be a curved plane. In such embodiments, the first, second, third, and fourth curved surfaces C1-C4 can be formed on/along the curved plane. In some embodiments, the curved plane can be a convex plane.

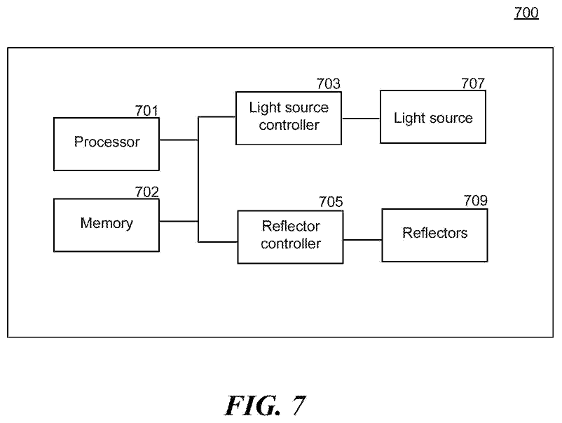

FIG. 7 is a schematic diagram of a system 700 in accordance with embodiments of the present technology. The system 700 includes a processor 701, a light-source controller 703, a reflector controller 705, a light source 707, and multiple reflectors 709. The light source controller 703 is configured to control the light source 707 to emit light rays in various combinations of brightness and color. The reflector controller 705 is configured to control the movements of the multiple reflectors 709. For example, the reflector controller 705 can instruct each reflector 709 to move to or stop at a specific location in its moving range MR (e.g., MR1, MR2, or MR3 discussed above with reference to FIG. 5).

The processor 701 is configured to coordinate the movements of the reflectors 709 and the light emitting of the light source 707, by communicating with both the light-source controller 703 and the reflector controller 705. For example, the processor 701 can be tasked (e.g., by a user) to present an image (e.g., from an image streaming source, a local storage, etc.) in a viewing area (e.g., the viewing areas Va, Vb, Vc, or Vd discussed above with reference to FIG. 3) of a screen during a first time period (e.g., 0.01-0.5 second). The processor 701 can then instruct the reflector controller 705 to move a first reflector of the reflectors 709 to a first position (e.g., where the light emitted from the light source 707 can be reflected to a first viewing area by the first reflector) and let the first reflector stay there during the first time period. During the same time period, the processor 701 also instructs the light-source controller 703 to control the light source 707 to emit light rays with particular brightness and color to be shown in the first viewing area.

In some embodiments, the processor 701 can employ multiple reflectors 709 to direct light from the light source 707 to multiple viewing areas (some of them can be overlapped). For example, the processor 701 can instruct the reflector controller 705 to move a second reflector of the reflectors 709 to a second position and let the second reflector stay there only during a second time period that is less than the first time period. During the remaining of the first time period (i.e., a third time period), the processor 701 can instruct the reflector controller 705 to move a third reflector of the reflectors 709 to a third position and let the third reflector stay there during the third time period. During the second time period, the processor 701 can instruct the light-source controller 703 to control the light source 707 to emitting light rays with a first set of characteristics (which are to be directed to a second viewing area by the second reflector). During the third time period, the processor 701 can instruct the light-source controller 703 to control the light source 707 to emitting light rays with a second set of characteristics (which are to be directed to a third viewing area by the third reflector).

By repeating the foregoing process of moving the reflectors 709 back and forth and coordinating with of the light source 707, the system 700 can present images in various viewing areas of a screen within a period of time.

In some embodiments, prior to emitting light from the light source 707, the processor 701 can verify that the reflectors 709 are at target positions, so as to ensure that the images are to be presented in desirable viewing areas. For example, referring back to FIG. 2A-2E, a processor (e.g., similar to the processor 707 as described) of the image displaying device 101 can verify that the reflector 103b is at the locations (e.g., as those shown in FIGS. 2A-2E) such that the light from the light source 101 can be directed to the corresponding locations (e.g., points 201, 203, 205, and 207) the viewing area Vb.

The system 700 can include a memory 702 for storing one or more programs for controlling the components (e.g., components 703, 705, 707, and 709) of the system 700.

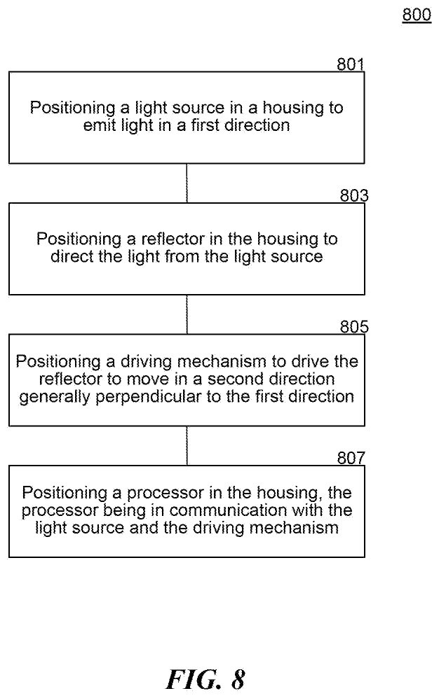

FIG. 8 is a flowchart illustrating a method 800 of assembling a display. The method 800 includes, at block 801, positioning a light source in a housing to emit light in a first direction. In some embodiments, the light source can, be an LED component. In some embodiments, the housing can be a structure made of plastic, resin, metal, or composite material. The housing is configured to hold and cover components of the display. The first direction can be a vertical direction, such as direction R1 shown in FIGS. 2A-2E.

At block 803, the method 800 includes positioning a reflector in the housing to direct the light from the light source. In some embodiments, the reflector can be positioned above the light source and configured to direct the light from the light source to a screen of the display. In some embodiments, the display can include one or more lenses or filters (e.g., the light adjusting element 401, the light filter 402, etc.) configured to adjust the characteristics of the light from the light source.

At block 805, the method 800 includes positioning a driving mechanism to drive the reflector to move in a second direction generally perpendicular to the first direction. The driving mechanism is positioned to drive the reflector to move in a second direction generally perpendicular to the first direction. In some examples, the driving mechanism can utilize an electromagnetic force to move the reflector. In some cases, the driving mechanism can utilize other suitable forces to move the reflector, such as hydraulic or pneumatic forces. In some embodiments, the driving mechanism can include an electrostatic component.

At block 807, the method 800 continues by positioning a processor in the housing. The processor is in communication with the light source and the driving mechanism and configured to coordinate the operations of these two components. In some embodiments, the processor can be a chip, a control unit/circuitry/logic, or other suitable devices.

In some embodiments, the method 800 can include positioning a screen so as to form an enclosure with the housing. The screen can have a viewing area which receives light directed from the reflector. In some embodiments, the display can include multiple reflectors. In such embodiments, the screen can include a plurality of viewing areas (some of them can overlap). Each of the plurality of viewing areas can receive light directed by a corresponding one of the reflectors.

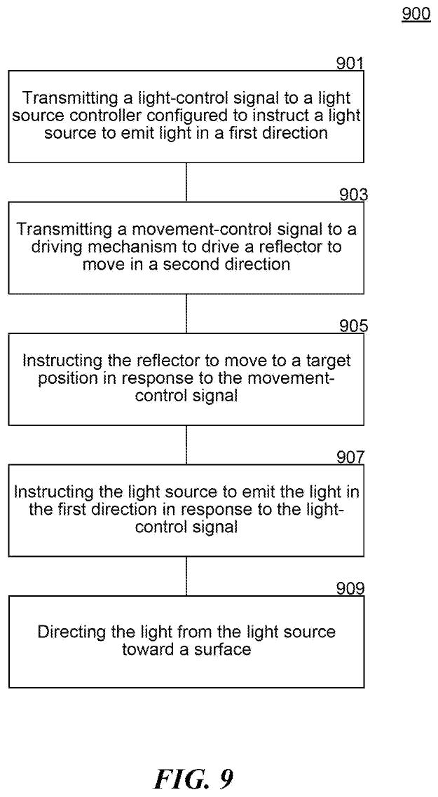

FIG. 9 is a flowchart illustrating a method 900 of generating an image on a surface. The method 900 includes, at block 901, transmitting (e.g., from a processor of a display) a light-control signal to a light-source controller configured to instruct a light source to emit light in a first direction. The light source can be an LED component. The light-source controller can be an LED control circuit, chip, or controller. The processor can be a device configure to control and coordinate operations of the components of the display.

At block 903, the method 900 includes transmitting (e.g., from the processor of the display) a movement-control signal to a driving mechanism to drive a reflector to move in a second direction. The second direction is generally perpendicular to the first direction. The operations of the reflector and the light source are coordinated by the processor so as to direct light with desirable characteristics to particular viewing areas during specific time periods.

At block 905, the method 900 includes instructing the reflector to move to a target position in response to the movement-control signal. In some embodiments, the processor can instruct the driving mechanism directly. In some embodiments, the processor can transmit the movement-control signal to a reflector controller (e.g., the reflector controller 705 in FIG. 7) and then the reflector controller can instruct the driving mechanism to move accordingly.

At block 907, the method 900 includes instructing (e.g., by the light-source controller) the light source to emit the light in the first direction in response to the light-control signal. At block 909, the method 900 includes directing, by the reflector, the light from the light source toward the surface. In some embodiments, the surface includes a viewing area of a screen of the display.

This disclosure is not intended to be exhaustive or to limit the present technology to the precise forms disclosed herein. The image displaying devices can display media received from streaming devices, smartphones, cable box, or another media source. For example, the image displaying devices disclosed herein can include ports (e.g., USB ports, HDMI ports, optical ports, connectors, etc.), transmitters, antennae, or other communication devices for communicating via a wired or wireless connection. In some embodiments, a home theater system includes an image displaying device and speakers. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (i) any single item in the list, (ii) all of the items in the list, or (iii) any combination of the items in the list. Additionally, the term “comprising” is used throughout to mean including at least the recited feature(s) such that any greater number of the same feature and/or additional types of other features are not precluded. Reference herein to “one embodiment,” “some embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

From the foregoing, it will be appreciated that specific embodiments of the present technology have been described herein for purposes of illustration, but that various modifications may be made without deviating from the scope of the invention. The present technology is not limited except as by the appended claims.

I claim:

1. An apparatus for generating an image on a surface, comprising:
a screen;
a housing positioned to hold the screen, the screen and the housing together forming an enclosure;
a light source positioned in the enclosure to emit light in a first direction;
a reflector positioned to direct the light from the light source toward the screen;
a driving mechanism positioned to drive the reflector to move in a second direction generally perpendicular to the first direction; and
a processor positioned in the housing, the processor being in communication with the light source and the driving mechanism so as to coordinate a movement of the reflector with the light from the light source.

2. The apparatus of claim 1, further comprising a light-source controller in communication with the processor and the light source.

3. The apparatus of claim 2, wherein the light source includes a light emitting diode (LED) component, and wherein the light-source controller includes an LED driving circuit.

4. The apparatus of claim 3, wherein the LED component is configured to emit the light in response to a light-control signal from the processor to the light controller.

5. The apparatus of claim 4, wherein the light-control signal is indicative of a set of characteristics of the light emitted by the LED component.

6. The apparatus of claim 4, wherein the driving mechanism is configured to move the reflector in response to a movement-control signal from the processor.

7. The apparatus of claim 6, wherein the movement-control signal corresponds to the light-control signal.

8. The apparatus of claim 1, wherein the reflector includes a curved surface.

9. The apparatus of claim 8, wherein the curved surface is positioned to direct the emitted light from the light source to a viewing area of the screen.

10. The apparatus of claim 1, wherein the reflector includes a first portion and a second portion positioned adjacent to the first portion, and wherein the first portion includes a first curved surface, and wherein the second portion includes a second curved surface.

11. The apparatus of claim 10, wherein the first curved surface has a first curvature, and wherein the second curved surface has a second curvature generally the same as the first curvature.

12. The apparatus of claim 1, wherein the driving mechanism includes a linear motor.

13. The apparatus of claim 1, wherein the driving mechanism includes a coil gun.

14. The apparatus of claim 1, wherein the driving mechanism includes a magnet.

15. The apparatus of claim 1, wherein the driving mechanism includes a pneumatic device.

16. A method for assembling a display, comprising:
positioning a light source in a housing to emit light in a first direction;
positioning a reflector in the housing to direct the light from the light source;
positioning a driving mechanism to drive the reflector to move in a second direction generally perpendicular to the first direction; and
positioning a processor in the housing, the processor being in communication with the light source and the driving mechanism so as to position the reflector based on operation of the light source.

17. The method of claim 16, further comprising positioning a screen so as to form an enclosure with the housing.

18. The method of claim 17, wherein the reflector is positioned to direct the light from the light source to a viewing area of the screen.

19. A method for generating an image on a surface, comprising:
transmitting, from a processor, a light-control signal to a light-source controller configured to instruct a light source to emit light in a first direction;
transmitting, from the processor, a movement-control signal to a driving mechanism to drive a reflector to move in a second direction, the second direction being generally perpendicular to the first direction;
instructing, by the processor, the reflector to move to a target position in response to the movement-control signal;
instructing, by the light-source controller, the light source to emit the light in the first direction in response to the light-control signal; and
directing, by the reflector, the light from the light source toward the surface.

20. The method of claim 19, further comprising verifying, by the processor, that the reflector is at the target position prior to instructing the light source to emit the light in the first direction in response to the light-control signal.

21. The method of claim 19, further comprising:
determining a location of the image to be displayed on the surface based on user(s) position information; and
determining the target position of the reflector based on the determined location.
